(19) United States
(12) Patent Application Publication
(10) Pub. No.: US 2012/0080819 A1
(43) Pub. Date: Apr. 5, 2012

(54) PATTERNING MOLD AND MANUFACTURING METHOD THEREOF

(75) Inventors: Eui Son Choi, Seoul (KR); Eun Soo Hwang, Seoul (KR); Young Tae Cho, Suwon-si (KR); Dong Min Kim, Suwon-si (KR); Jeong Gil Kim, Suwon-si (KR); Jong Woo Lee, Suwon-si (KR); Eun Ah Park, Yongin-si (KR)

(73) Assignee: SAMSUNG ELECTRONICS CO., LTD., Suwon-si (KR)

(21) Appl. No.: 13/221,395

(22) Filed: Aug. 30, 2011

(30) Foreign Application Priority Data
Oct. 4, 2010 (KR) 10-2010-0096338

(51) Int. Cl. B29C 59/02

(52) U.S. Cl. 264/293; 425/385

(57) ABSTRACT

Disclosed herein is a patterning mold to form a micropattern on a substrate or glass. The disclosed patterning mold includes a body having a patterning part formed at one end of the body. The patterning part may be configured to contact a surface of the substrate, to form a channel. In example embodiments, an ink supply passage communicating with the channel may be formed in the patterning mold, to supply an ink to the channel. In example embodiments, a fixing member is coupled to an exterior of the transfer body, to prevent or reduce deformation of the exterior of the transfer body.

### CROSS-REFERENCE TO RELATED APPLICATION

This application claims priority under 35 U.S.C. §119 to Korean Patent Application No. 2010-96338 filed on Oct. 4, 2010 in the Korean Intellectual Property Office (KIPO), the entire contents of which is incorporated herein by reference.

### BACKGROUND

1. Field

Example embodiments relate to a patterning mold for forming a micropattern on a substrate, and a manufacturing method thereof.

2. Description of the Related Art

Recently, a patterning process, which uses printing, has been a focus of attention as a process for forming a micropattern on a substrate. This is because the patterning process, which uses printing, requires fewer pre-processing or post-processing steps and exhibits a rapid process rate, as compared to other conventional patterning processes, for example, a patterning process employing photolithography.

Examples of such printing-based patterning processes include a gravure or gravure offset process, a reverse offset process, a flexography process, and a micro-contact process, which use a blanket or mold to transfer a micropattern to a substrate. For a material of such a mold, a material exhibiting low surface energy, such as poly dimethyl siloxane (PDMS), as compared to the substrate, is generally used, taking into consideration bonding force to the substrate. However, such a mold material may be unsuitable for a mold to manufacture a substrate requiring high precision because the material exhibits low mechanical strength and is readily deformed.

### SUMMARY

Example embodiments provide a patterning mold capable of forming a micropattern on a substrate, for example, glass, and a manufacturing method thereof

Example embodiments also provide a patterning mold having a structure capable of reinforcing mechanical rigidity, and a manufacturing method thereof.

Example embodiments also provide a patterning mold with a simple structure capable of forming a micropattern on a substrate, for example, glass, and a manufacturing method thereof.

Additional aspects of example embodiments will be set forth in part in the description which follows and, in part, will be obvious from the description, or may be learned by practice of example embodiments.

In accordance with example embodiments, a patterning mold may include a transfer body and a fixing member. In example embodiments the transfer body may include a patterning part at one end of the transfer body and the patterning part may be configured to contact a surface of a substrate to form a channel. In example embodiments, the transfer body may further include an ink supply passage communicating with the patterning part and the ink supply passage may be configured to supply ink to the channel. In example embodiments, the fixing member may be coupled to an exterior of the transfer body and the fixing member may be configured to reduce deformation of the transfer body.

In accordance with example embodiments, a patterning mold molding apparatus may include a first mold and a second mold. The first mold may include one of an injection port through which a material of a transfer body is injected and an opening to remove air bubbles formed when the material of the transfer body is cured. The second mold may be configured to couple to the first mold and the second mold may include a master pattern configured to form a patterning part of the transfer body. In example embodiments, the first mold and the second mold may be configured to form a cavity into which the material of the transfer body is injected to form the transfer body.

In accordance with example embodiments, a method for manufacturing a patterning mold usable to form a micropattern on a substrate may include: providing a first mold, the first mold including an injection port to allow injection of a material for a transfer body; providing a second mold, the second mold including a master pattern to form a patterning part of the transfer body; coupling the first and second molds to form a cavity; injecting the transfer body material into the cavity formed by the first and second molds, through the injection port; arranging a pin at an upper portion of the first mold, to form an ink supply passage in the transfer body; curing the transfer body material, to form the transfer body; and separating the second mold from the transfer body and the first mold coupled with the transfer body.

In accordance with example embodiments, a patterning mold usable to form a micropattern on a substrate may include a body, a patterning part formed at one end of the body, the patterning part coming into contact with one surface of the substrate, to form a channel, an ink supply passage communicating with the channel, to supply an ink to the channel, and a fixing member coupled to an exterior of the transfer body, to prevent the exterior of the transfer body from being deformed.

The patterning part may include convex portions to come into contact with the substrate, and concave portions each arranged between adjacent ones of the convex portions. The substrate and the convex and concave portions may define the channel, to allow the ink to be introduced into the channel.

At least one of the convex and concave portions may communicate with the ink supply passage.

An air outlet may be provided at one of the adjacent convex portions, to communicate with an outside of the patterning mold.

A step may be provided at one side of the convex portion having the air outlet. The step may define the air outlet communicating with the outside of the patterning mold, together with the substrate.

The fixing member may be provided with irregularities to enhance a coupling force to the body.

The irregularities may have a thread shape.

The fixing member may be provided with a reinforcing member at an inner peripheral surface of the fixing member. The reinforcing member may be coupled with the body, to prevent the transfer body from being deformed due to gravity.

In accordance with another aspect of example embodiments, a patterning mold molding apparatus usable to form a micropattern on a substrate may include a first mold, a second mold coupled to the first mold, the second mold comprising a master pattern to form a patterning part at a transfer body, and an injection port, through which a material of the transfer body is injected into a cavity formed by the first and second molds.

The material may be cured in the cavity formed by the first and second molds, to form the transfer body. The transfer body may be separated from the second mold in a state of being coupled with the first mold, to form a patterning mold, together with the first mold.

The injection port may be provided at an upper portion of the first mold.

The first mold may include an opening to remove air bubbles formed when the material of the transfer body is cured.

The first mold may include irregularities to enhance a coupling force to the transfer body.

A positioning pin may be coupled to the injection port, to form a fluid passage communicating with the patterning part at the transfer body.

The first mold may include a pin holding member to fix the positioning pin to the first mold.

The patterning part may include convex portions to come into contact with the substrate, and concave portions each arranged between adjacent ones of the convex portions. The substrate and the convex and concave portions may define a channel, to allow a fluid to be introduced into the channel.

At least one of the convex and concave portions may communicate with the fluid passage.

An air outlet may be provided at one of the adjacent convex portions, to communicate with an outside of the patterning mold.

A step may be provided at one side of the convex portion having the air outlet. The step may define the air outlet communicating with the outside of the patterning mold, together with the substrate.

The second mold may include an inclined portion to allow the transfer body to be easily separated from the second mold.

The first mold may be provided with a reinforcing member at an inner peripheral surface of the first mold. The reinforcing member may be fixed to the transfer body during curing of the transfer body material.

In accordance with example embodiments, a method for manufacturing a patterning mold usable to form a micropattern on a substrate may include arranging a first mold formed with an injection port to allow injection of a material for a transfer body, arranging a second mold having a master pattern to form a patterning part at the transfer body, coupling the first and second molds, injecting the transfer body material into a cavity formed by the first and second molds, through the injection port, arranging a pin at an upper portion of the first mold, to form an ink supply passage in the transfer body, and curing the transfer body material, to form the transfer body, and separating the second mold from the transfer body and the first mold coupled with the transfer body.

The first mold may include irregularities having a thread shape.

The first mold may be provided with a reinforcing member at an inner peripheral surface of the first mold. The reinforcing member may be fixed to the transfer body during curing of the transfer body material.

The second mold may include an inclined portion to allow the transfer body to be easily separated from the second mold.

The transfer body material may be a thermosetting resin or a photocurable resin.

### BRIEF DESCRIPTION OF THE DRAWINGS

These and/or other aspects of the invention will become apparent and more readily appreciated from the following description of example embodiments, taken in conjunction with the accompanying drawings of which:

FIG. 1 is a sectional view illustrating a patterning mold according to example embodiments;

FIG. 2 is a sectional view illustrating a procedure for forming a micropattern on a substrate or a glass using the patterning mold according to example embodiments;

FIG. 3 is a perspective view illustrating a patterning mold molding apparatus for manufacture of the patterning mold according to example embodiments;

FIGS. 4A to 4D are sectional views illustrating processing steps for manufacturing the patterning mold according to example embodiments;

FIG. 5 is a view illustrating a process for manufacturing a master pattern to be used in the manufacture of the patterning mold according example embodiments;

FIG. 6 is a sectional view illustrating a patterning mold according to example embodiments;

FIG. 7 is a perspective view illustrating a patterning mold molding apparatus for manufacture of the patterning mold according to example embodiments; and

FIGS. 8A and 8B are sectional views each illustrating a reinforcing member coupled to patterning molds of example embodiments.

### DETAILED DESCRIPTION

Example embodiments will be described more fully hereinafter with reference to the accompanying drawings, in which example embodiments are shown. The present invention may, however, be embodied in many different forms and should not be construed as limited to example embodiments as set forth herein. Rather, example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers that may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. Throughout the specification, the same reference numerals designate the same constituent elements, respectively.

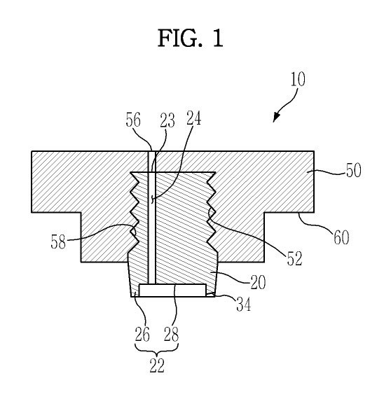

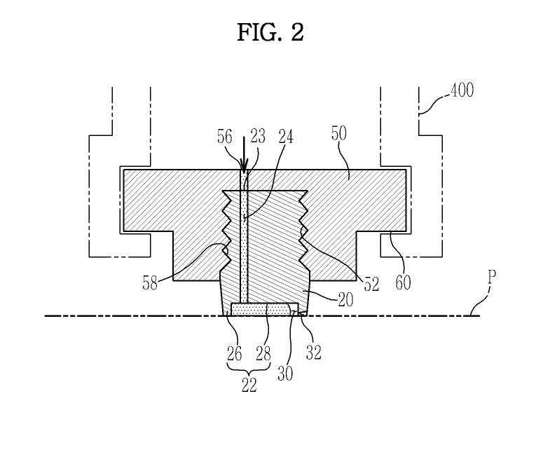

FIG. 1 is a sectional view illustrating a patterning mold according to example embodiments. FIG. 2 is a sectional view illustrating a procedure for forming a micropattern on a substrate or a glass using the patterning mold according to example embodiments.

As shown in FIGS. 1 and 2, the patterning mold, which is designated by reference numeral 10, may include a transfer body 20 and a fixing member 50.

The transfer body 20 may be configured to come into contact with a substrate or glass P in a process of forming a micropattern on the substrate or glass P. The transfer body 20 may include a patterning part 22, an ink supply port 23, and an ink supply passage 24.

In example embodiments, the patterning part 22 may be provided at one end of the transfer body 20, to form a channel while coming into contact with the substrate or glass P. The patterning part 22 may include convex portions 26 that come into contact with the substrate or glass P, and concave portions 28 each arranged between adjacent ones of the convex portions 26.

In example embodiments, the convex portions 26 may directly come into contact with the substrate or glass P, to prevent ink introduced into the patterning part 22 from being outwardly leaked or to at least reduce the amount of ink that may be leaked outwardly. The concave portions 28, which may be arranged between the adjacent convex portions 26, may form channels 30 (FIG. 2), into which ink will be introduced, together with the convex portions 26 directly in contact with the substrate or glass P. That is, the convex portions 26 and concave portions 28 form an embossed pattern corresponding to a micropattern to be formed on the substrate or glass P. Referring to FIGS. 1 and 2, only two convex portions 26, one concave portion 28 formed between the convex portions 26, and one channel 30 formed by the convex portions 26 and concave portion 28 are shown, for simplicity of illustration. The following description will be given only in conjunction with the illustrated structure, for simplicity of description.

An air outlet 32, which may communicate with the outside of the patterning mold 10, may be provided at one of the convex portions 26. The air outlet 32 may function to avoid a phenomenon in which the channel has a portion where no ink is introduced, as the internal pressure of the channel 30 increases in accordance with introduction of ink into the channel 30. The air outlet 32 may be defined by a first step 34 formed at one of the convex portions 26, and one surface of the substrate or glass P facing the first step 34.

The air outlet 32 may be formed to have a very small size capable of allowing gas, for example, air, to pass through the air outlet 32, but preventing or inhibiting a fluid, for example, ink, from passing through the air outlet 32.

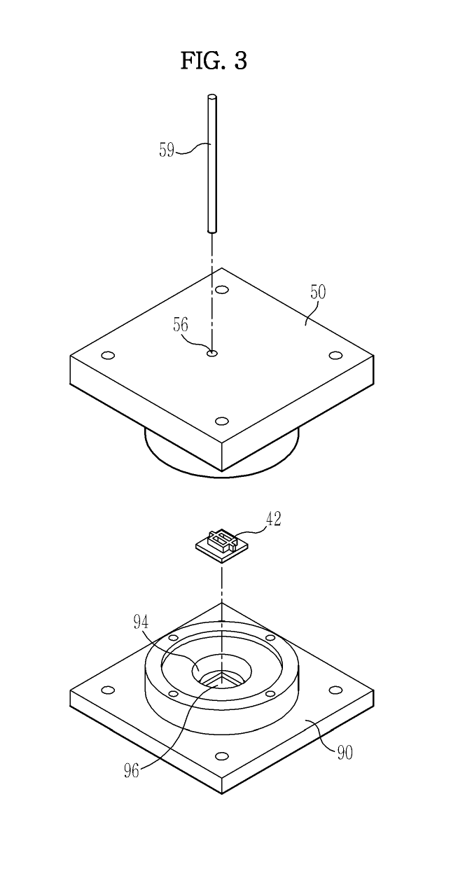

The patterning part 22, which may include the convex and concave portions 26 and 28, may be formed at the transfer body 20 by a master pattern 42 (FIG. 3) provided at a second mold 90 (FIG. 3). This will be described in detail later.

The ink supply port 23 and ink supply passage 24 are provided to supply ink to the channel 30.

The ink supply port 23 may be formed at the other end of the transfer body 20, namely, an end of the transfer body 20 opposite to one end of the transfer body 20 where the patterning part 22 is formed. The ink supply passage 24 may be formed to extend through the transfer body 20. One end of the ink supply passage 24 may communicate with the ink supply port 23, whereas the other end of the ink supply passage 24 may communicate with the channel 30. Thus, the ink supply passage 24 may allow ink supplied through the ink supply port 23 to be introduced into the channel 30.

The ink supply passage 24, which may communicate with the channel 30, may communicate with one side of the concave portion 28, as shown in FIG. 1. Although not shown, the ink supply passage 24 may communicate with one side of one of the convex portions 26.

In example embodiments, the fixing member 50 may be coupled to an exterior of the transfer body 20, to prevent the exterior of the transfer body 20 from being deformed or to at least reduce a deformation of the exterior of the transfer body 20. The fixing member 50 includes a transfer body fixing portion 52, and an injection port 56.

The transfer body fixing portion 52 may have a shape corresponding to the transfer body 20, in order to allow the transfer body 20 to be formed inside the transfer body fixing portion 52 while having a shape defined by the transfer body fixing portion 52, and to be coupled with the transfer body fixing portion 52. The transfer body fixing portion 52 may include irregularities 58 to prevent the transfer body 20 from being separated from the fixing member 50.

The irregularities 58 may be provided at an inner surface of the transfer body fixing portion 52, to enhance the coupling force between the transfer body 20 and the transfer body fixing portion 52, thereby indirectly reinforcing the transfer body 20.

As shown in FIG. 2, the irregularities 58 may be formed to have a thread shape. When the irregularities 58 are formed to have a thread shape, this formation may be achieved using a standard thread machining tool, as opposed to a special purpose-built machining tool.

The injection port 56 is provided at an upper portion of the fixing member 50, to communicate with the ink supply port 23 and ink supply passage 24 formed at the transfer body 20.

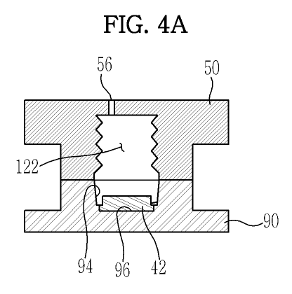

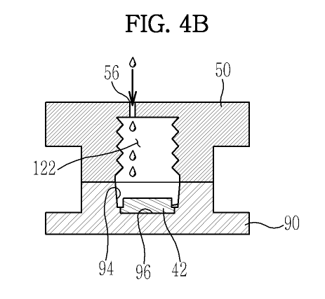

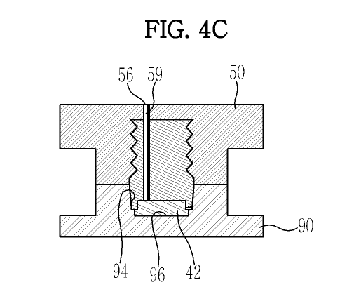

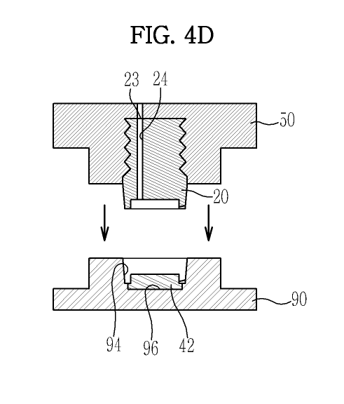

In example embodiments, the injection port 56 functions as a passage to inject a material of the transfer body 20 into a cavity 122 (see FIG. 4A) defined by the fixing member 50 and the second mold 90 (FIG. 3 and FIG. 4A) when the patterning mold 10 is manufactured. When the material of the transfer body 20 is cured to form the transfer body 20, the injection port 56 also functions as a passage to supply ink to the transfer body 20.

Although not shown, the injection port 56 may be separately formed such that it does not communicate with the ink supply port 23 and ink supply passage 24. That is, a hole communicating with the ink supply port 23 may be separately formed at the upper portion of the fixing member 50, in addition to the injection port 56. In this case, the material of the transfer body 20 may be injected through the injection port 56 in the procedure of manufacturing the patterning mold 10, whereas ink is injected through the hole in the procedure of forming a micropattern on the substrate or glass P.

In example embodiments, a second step 60 may be provided at the fixing member 50. The second step 60 may be coupled to patterning equipment 400 as shown in FIG. 2.

The patterning equipment 400 may be arranged over the substrate or glass P. The patterning mold 10, which includes the fixing member 50, may be coupled to one end of the patterning equipment 400. The patterning equipment 400 may operate to form a micropattern having a desired shape on the substrate or glass P while feeding the patterning mold 10.

The second step 60, which may be provided at the fixing member 50, may be firmly fixed to one end of the patterning equipment 400. The shape of the second step 60 may be changed in accordance with the structure or shape of the end of the patterning equipment 400.

In example embodiments, the material of the fixing member 50 may be an aluminum alloy or stainless steel alloy.

As shown in FIG. 2, the patterning mold 10 may be fed in a horizontal or vertical direction in a state of being coupled to one end of the patterning equipment 400, to come into contact with the substrate or glass P, thereby forming the channel 30. Ink may be supplied to the channel 30 through the ink supply port 23 and ink supply passage 24, and may be cured in the channel 30. Thus, a micropattern having a desired shape may be formed on the substrate or glass P.

Because the transfer body 20 may be coupled to the fixing member 50, it may be possible to reduce or minimize deformation of the transfer body 20 during the procedure in which the transfer body 20 is fed by the patterning equipment 400 or comes into contact with the substrate or glass P. Accordingly, it may be possible to precisely form a desired micropattern.

Hereinafter, an apparatus for manufacturing the above-described patterning mold 10 and a molding process for the patterning mold 10 will be described in detail.

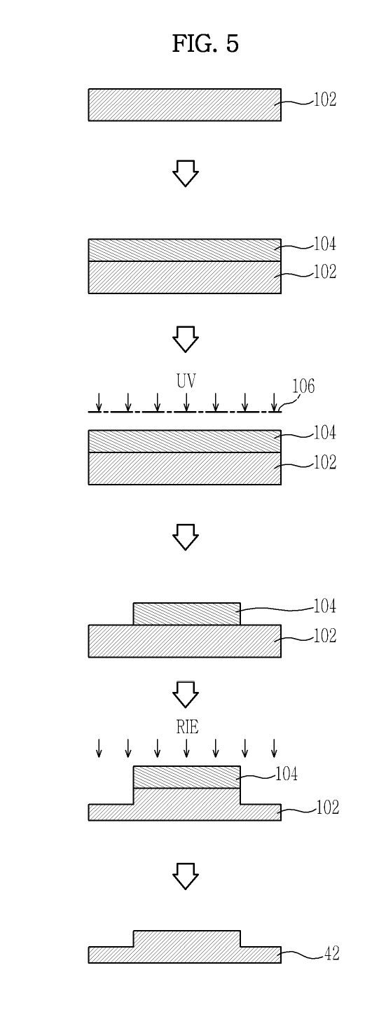

FIG. 3 is a perspective view illustrating a patterning mold molding apparatus for manufacture of the patterning mold according to example embodiments. FIGS. 4A to 4D are sectional views illustrating processing steps for manufacturing the patterning mold according to example embodiments. FIG. 5 is a view illustrating a process for manufacturing a master pattern to be used in the manufacture of the patterning mold according to example embodiments.

Referring to FIG. 3, a patterning mold molding apparatus 70 for manufacturing the patterning mold 10 is shown. The patterning mold molding apparatus 70 includes a first mold 50 and a second mold 90.

The first mold 50 may be coupled to the transfer body 20, to form the patterning mold 10. The structure and function of the first mold 50 are identical to those of the fixing member 50. Accordingly, no description will be given of the first mold 50.

The second mold 90 may be coupled with the first mold 50, to form the cavity 122 (see FIG. 4A), into which the material of the transfer body 20 is injected. The second mold 90 may include a master pattern 42 and an inclined portion 94.

The master pattern 42 may be arranged in a groove 96 formed in the second mold 90. The master pattern 42 forms the patterning part 22 at the transfer body 20.

As described above, the patterning part 22 may include the convex portions 26 to come into contact with the substrate or glass P, and the concave portions 28 each arranged between adjacent convex portions 26. Accordingly, the master pattern 42 may form the patterning part 22 so as to have a shape corresponding to the patterning part 22 including the convex and concave portions 26 and 28. That is, the master pattern 42 forms a depressed pattern corresponding to the embossed pattern, which is formed by the convex and concave portions 26 and 28 of the patterning part 22, to have a shape corresponding to the micropattern to be formed on the substrate or glass P.

A patterning process using photoresist may be used to manufacture the master pattern 42. As shown in FIG. 5, a photoresist film 104 may be coated over a surface of a silicon (Si) wafer 102. A photomask 106 having a desired pattern may then be arranged on the photoresist film 104. The resultant structure may then be exposed to ultraviolet (UV) light. When a developer is applied to the photoresist film 104, once the exposure process is completed, the photoresist film 104, except for an unexposed portion thereof shielded by the photomask 106, may be removed to a certain depth. Finally, the photoresist film 104 subjected to the above process is etched in accordance with a reactive ion etching (RIE) process. Thus, the master pattern 42, which has a desired pattern shape, is obtained.

As described above, the master pattern 42 may be separately manufactured through the patterning process, which uses photoresist, and may then be arranged in the groove 96 formed at the second mold 90. However, the master pattern 42 may also be directly formed at the groove 96 without being separately manufactured. That is, the master pattern 42 may be directly formed at the groove 96 by machining a desired pattern in the groove 96 by use of a machining tool.

The inclined portion 94, which extends at an incline, may be arranged above the groove 96. The inclined portion 94 allows the transfer body 20 to be easily separated from the second mold 90 in a state of being coupled with the first mold 50.

It may be possible to more easily separate the transfer body 20 from the second mold 90 by performing a releasing treatment, for example, coating a releasing agent over the inclined portion 94.

Hereinafter, the process of manufacturing the patterning mold 10 according to example embodiments, using the first mold 50 and second mold 90, will be described.

As shown in FIG. 4A, the master pattern 42 may first arranged at the groove 96 of the second mold 90. Thereafter, the first mold 50 and second mold 90 are coupled such that the cavity 122, into which the material of the transfer body 20 will be injected, is formed.

In this state, the transfer body fixing portion 52 formed at the first mold 50 is coupled with the inclined portion 94 formed at the second mold 90, thereby forming the cavity 122, into which the material of the transfer body 20 will be injected, as a space having a shape corresponding to the exterior of the transfer body 20.

Under the condition that the first mold 50 and second mold 90 are coupled, the material of the transfer body 20 is injected through the injection port 56 provided at the first mold 50, as shown in FIG. 4B.

As the material for the transfer body 20, any material may be used, so long as the material is present in a liquid phase having flowability before heat or photo treatment, but is cured after heat or photo treatment, thereby being stabilized in a solid phase. For a material having such properties, a thermosetting resin or a photocurable resin may be used.

Upon completion of the process of injecting the material of the transfer body 20, a positioning pin 59 is inserted into the injection port 56, as shown in FIG. 4C.

The positioning pin 59 functions to form the ink supply port 23 and ink supply passage 24 in the transfer body 20. The body of the positioning pin 59 may be arranged to extend through the cavity 122 defined by the first mold 50 and second mold 90. One end of the ink supply passage 24 may come into contact with one surface of the master pattern 42, to communicate with the channel 30.

After the insertion of the positioning pin 59 into the injection port 56, as shown in FIG. 4C, a process of curing the material of the transfer body 20 injected into the cavity 122 formed by the first mold 50 and second mold 90 is carried out. Where the material of the transfer body 20 is a thermosetting resin or a photocurable resin, a heat treatment process or a photo treatment process may be additionally carried out.

The material of the transfer body 20 may be firmly fixed to the first mold 50 during curing.

After the material of the transfer body 20 is completely cured, the first mold 50 and the transfer body 20 coupled and fixed to the first mold 50 are separated from the second mold 90, as shown in FIG. 4D. Thereafter, the positioning pin 59 is separated from the transfer body 20.

As the first mold 50 and the transfer body 20 coupled and fixed to the first mold 50 are separated from the second mold 90, they form the patterning mold 10 to form a micropattern on the substrate or glass P.

In example embodiments, since the second mold 90 may be formed with the inclined portion 94, and the inclined portion 94 may be subjected to a releasing treatment, the patterning mold 10 may be easily separated from the second mold 90.

Because the patterning mold 10 may be manufactured by coupling the transfer body 20, which may have low mechanical strength, to the first mold 50, it may be possible to prevent the patterning mold 10 from being deformed in the procedure of forming a micropattern on the substrate or glass P, using the patterning mold 10. In the alternative, because the patterning mold 10 may be manufactured by coupling the transfer body 20, which may have low mechanical strength, to the first mold 50, it may be possible to reduce deformations of the patterning mold 10 in a procedure of forming a micropattern on the substrate or glass P, using the patterning mold 10. Accordingly, it may be possible to precisely form a desired micropattern.

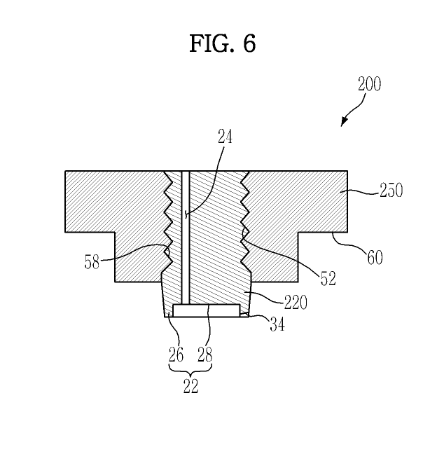

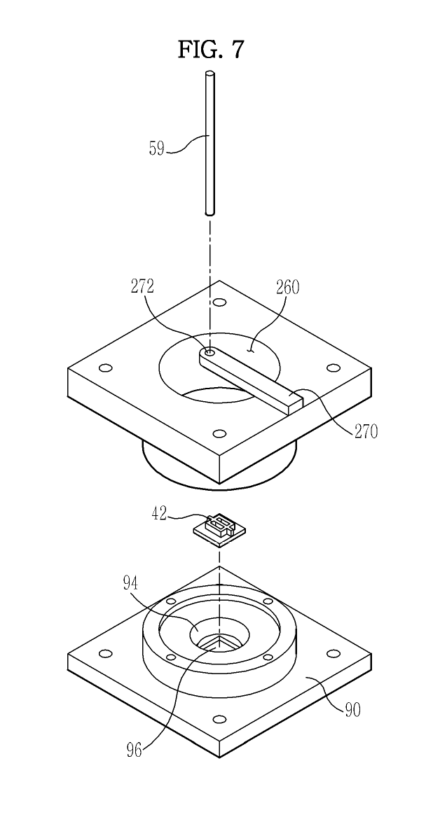

FIG. 6 is a sectional view illustrating a patterning mold according to example embodiments. FIG. 7 is a perspective view illustrating a patterning mold molding apparatus for manufacture of the patterning mold illustrated in FIG. 6.

As shown in FIGS. 6 and 7, the patterning mold of example embodiments, which is designated by reference numeral 200, has features in that an opening 260 is formed at an upper portion of a first mold 250, and a transfer body 220 is formed to extend throughout the first mold 250.

In example embodiments, because the opening 260 is formed at the upper portion of the first mold 250 it may be possible to prevent or reduce formation of air bubbles by the opening 260 in the procedure in which the material of the transfer body 20 is cured.

If the opening 260 is not provided, air bubbles formed in the transfer body 20 due to introduction of air into the material of the transfer body 20 may be left in the transfer body 20 without being outwardly discharged, because the injection port 56 is in a closed state by the positioning pin 59. Such air bubbles may lower the strength of the transfer body 20. When such air bubbles are present in the ink supply passage 24 formed in the transfer body 20, they may prevent or reduce ink from being smoothly supplied to the channel 30.

The opening 260 may allow air bubbles formed during the procedure of curing the material of the transfer body 20 to move upwardly and then to exit outwardly, thereby preventing or reducing air bubbles from being left in the transfer body 20.

A pin holding member 270, which will be coupled to the positioning pin 59, may be provided at one side of the top of the first mold 250.

Where the opening 260 is formed at the upper portion of the first mold 250, it may be necessary to use a structure for fixing the positioning pin 59 during the procedure of manufacturing the patterning mold 200.

In example embodiments, one end of the pin holding member 270 may be mounted to one side of the top of the first mold 250. A coupling hole 272 may be provided at the other end of the pin holding member 270, to be coupled with the positioning pin 59.

In example embodiments, the constituent elements of the patterning mold 200 (except for the opening 260 and pin holding member 270) and the manufacturing process carried out using the patterning mold 200 may be identical to those of the patterning mold 10, as previously described, and the manufacturing process carried out using the patterning mold 10, respectively. Accordingly, no further description will be given of the patterning mold 200 and the manufacturing process carried out using the patterning mold 200.

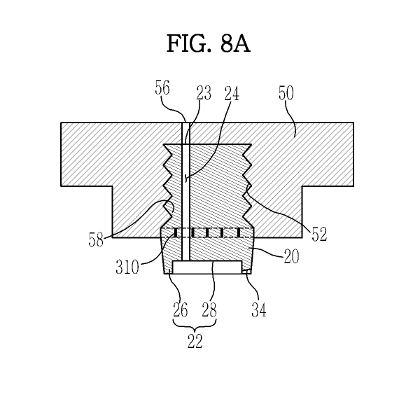

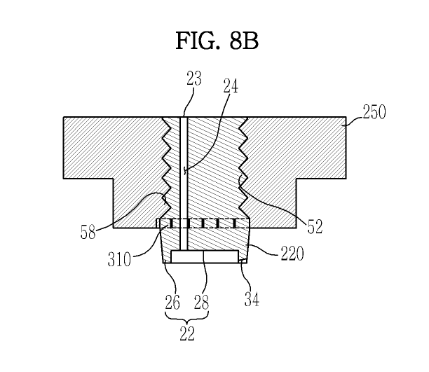

FIGS. 8A and 8B are sectional views illustrating reinforcing members coupled to patterning molds according to example embodiments.

As shown in FIGS. 8A and 8B, a reinforcing member 310 may be coupled to the patterning mold 10 or 200 according to example embodiments.

Where the patterning mold 10 or 200 has a large size such that the area of the transfer body 20 or 220 increases over a certain area, there may be a phenomenon in which the transfer body 20 or 220 is deformed due to gravity.

The reinforcing member 310 may be provided at an inner peripheral surface of the first mold 50 or 250. The reinforcing member 310 may be fixed to the transfer body 20 or 220 when the material of the transfer body 20 or 220 is cured, thereby reinforcing the transfer body 20 or 220 and the first mold 50 or 250.

In example embodiments, even when the patterning mold 10 or 200 has a relatively large size, it may be possible to perform a micropattern forming process while maintaining relatively high precision, without an excessive deformation phenomenon occurring at the transfer body 20 or 220 due to gravity, in accordance with use of the reinforcing member 310.

As apparent from the above description, deformation of a patterning mold may be reduced or minimized in the procedure in which a micropattern is formed on the substrate or glass. Accordingly, an improvement in product quality may be achieved.

Also, since a deformation of the patterning mold is prevented, reduced, or minimized in the procedure in which a micropattern is formed on the substrate or glass, it may be possible to prevent, reduce, or minimize formation of poor products caused by deformation of the patterning mold.

Although example embodiments have been shown and described, it would be appreciated by those skilled in the art that changes may be made in example embodiments without departing from the principles and spirit of the invention, the scope of which is defined in the claims and their equivalents.

What is claimed is:

1. A patterning mold comprising:
a transfer body, the transfer body including a patterning part at one end of the transfer body, the patterning part configured to contact a surface of a substrate to form a channel, the transfer body further including an ink supply passage communicating with the patterning part, the ink supply passage being configured to supply ink to the channel; and
a fixing member coupled to an exterior of the transfer body, the fixing member being configured to reduce deformation of the transfer body.

2. The patterning mold according to claim 1, wherein
the patterning part includes convex portions configured to contact the substrate and concave portions between adjacent convex portions.

3. The patterning mold according to claim 2, wherein at least one of the convex and concave portions communicates with the ink supply passage.

4. The patterning mold according to claim 3, wherein at least one of the convex portions includes an air outlet.

5. The patterning mold according to claim 4, wherein the at least one of the convex portions that includes the air outlet includes a step defining the air outlet.

6. The patterning mold according to claim 1, wherein the fixing member includes irregularities to enhance a coupling force between the transfer body and the fixing member.

7. The patterning mold according to claim 6, wherein the irregularities have a thread shape.

8. The patterning mold according to claim 1, wherein the fixing member includes a reinforcing member at an inner peripheral surface thereof, and the reinforcing member is coupled with the transfer body to reduce deformation of the transfer body by gravity.

9. A patterning mold molding apparatus, comprising:
a first mold, the first mold including one of an injection port through which a material of a transfer body is injected and an opening to remove air bubbles formed when the material of the transfer body is cured;
a second mold configured to couple to the first mold, the second mold including a master pattern configured to form a patterning part of the transfer body, wherein the first mold and the second mold are configured to form a cavity into which the material of the transfer body is injected to form the transfer body.

10. The patterning mold molding apparatus according to claim 9, wherein the second mold includes an inclined portion to allow the transfer body to separate from the second mold.

11. The patterning mold molding apparatus according to claim 10, wherein the injection port is at an upper portion of the first mold.

12. The patterning mold molding apparatus according to claim 10, wherein the opening extends through the first mold.

13. The patterning mold molding apparatus according to claim 10, wherein the first mold includes irregularities to enhance a coupling force between the transfer body and the first mold.

14. The patterning mold molding apparatus according to claim 10, further comprising:
a positioning pin in the one of the injection port and the opening to form a fluid passage communicating with the patterning part at the transfer body.

15. The patterning mold molding apparatus according to claim 14, wherein the first mold includes a pin holding member to support the positioning pin.

16. The patterning mold molding apparatus according to claim 15, wherein
the master pattern is configured to form the patterning part to have convex portions configured to contact a substrate, and to form concave portions between adjacent convex portions.

17. The patterning mold molding apparatus according to claim 16, wherein the positioning pin is configured to form the fluid passage to be in communication with at least one of the convex and concave portions.

18. The patterning mold molding apparatus according to claim 17, wherein at least one of the convex portions includes an air outlet.

19. The patterning mold molding apparatus according to claim 18, wherein the at least one of the convex portions that includes the air outlet includes a step.

20. The patterning mold molding apparatus according to claim 10, wherein the inclined portion is at least partially covered with a release agent to allow the transfer body to be easily separated from the second mold.

21. The patterning mold molding apparatus according to claim 10, wherein
the first mold includes a reinforcing member at an inner peripheral surface of the first mold, and the reinforcing member is configured to fix the transfer body.

22. A method for manufacturing a patterning mold usable to form a micropattern on a substrate, comprising:
providing a first mold, the first mold including an injection port to allow injection of a material for a transfer body;
providing a second mold, the second mold including a master pattern to form a patterning part of the transfer body;
coupling the first and second molds to form a cavity;
injecting the transfer body material into the cavity formed by the first and second molds, through the injection port;
arranging a pin at an upper portion of the first mold, to form an ink supply passage in the transfer body;
curing the transfer body material, to form the transfer body; and
separating the second mold from the transfer body and the first mold coupled with the transfer body.

23. The method according to claim 22, wherein the first mold includes irregularities having a thread shape.

24. The method according to claim 22, wherein the first mold includes a reinforcing member at an inner peripheral surface of the first mold, and the reinforcing member is fixed to the transfer body during curing of the transfer body material.

25. The method according to claim 22, wherein the second mold includes an inclined portion to allow the transfer body to be easily separated from the second mold.

26. The method according to claim 22, wherein the transfer body material is one of a thermosetting resin and a photocurable resin.
